(19) United States
(12) Patent Application Publication
(10) Pub. No.: US 2004/0064442 A1
(43) Pub. Date: Apr. 1, 2004

(54) Incremental search engine

(76) Inventor: Steven Gregory Popovitch, Ann Arbor, MI (US)

Correspondence Address: STEVEN POPOVITCH, 704 N. CHIPMAN, OWOSSO, MI, 48867, US

(21) Appl. No.: 10/259,056

(22) Filed: Sep. 27, 2002

(51) Int. Cl. G06F 7/00

(52) U.S. Cl. 707/3

(57) ABSTRACT

An incremental search engine method, performed on a server computer system connected to a network, is disclosed. The method allows to provide incremental search results to a large number of users in a timely and efficient fashion, facilitating the discovery of new information on the Internet or in corporate intranets. Users submit queries, which are stored on the server computer system. Once a query has been submitted, it is automatically checked against any new or modified documents retrieved from the network by a difference crawler, and new matches are presented to the submitter of the query. In the case of modified documents, only the novel portion of the document is considered for determining the new matches. For

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The disclosed invention relates generally to information retrieval methods and systems and, more particularly, to search engines. Still more particularly, the present invention discloses a method allowing to provide in an efficient manner an incremental search facility to a large number of users, facilitating the discovery of new information on the Internet or in corporate intranets.

### BACKGROUND OF THE INVENTION

In the past decade, there has been an explosive growth in the amount of text and multimedia information available on the Internet and other data networks. Attempts have been made to organize this information in hierarchical directories, in order to provide a natural navigation tool to end-users. Because of the sheer volume of information now available, such directories have become increasingly difficult to maintain and navigate. As a result, end-users are increasingly relying on text based search engines in order to locate information of interest.

Search engines are software systems, running on server computers, which create an index of the documents available on a network by crawling through the network, following the links embedded in the documents they reach. They also provides a query interface, often in the form of a web page displayed in a web browser running on a client computer, which allows users to submit queries against the index, and returns a list of pointers to documents matching the query. This list of matching documents often includes, for each document: the document's title; the document's network address or URL (Universal Resource Locator); and sometimes a few lines of text, selected among those containing the query keywords, extracted from the body of the document.

Search engines are excellent research tools, allowing to quickly locate relevant information. As a result, they have been widely deployed both on the public Internet network and on corporate intranets (private networks). The best global Internet search engines, such as the one provided by Google, index and provide a search interface to billions of documents available on the internet, allowing anyone to efficiently search this vast repository of information.

One feature not addressed by search engines is the discovery of new information. The Internet or corporate networks are not static repositories of documents, but are constantly changing to include new documents or updates to old documents. However, the very strength of search engines, which is the breadth of the domain searched and the volume of documents returned, make them extremely difficult to use for locating new or updated information.

For example, a computer scientist interested in journaling file systems may send the “journaling file system” query to the Google search engine, which today returns a list of about 8,000 document references. Browsing these documents would likely give the scientist a good feel about the state of the art on this topic, and may be satisfactory at the time.

However, the scientist may want to keep up to date with the research on journaling file systems, and send the same query to the Google search engine a few weeks later. This search would likely return again 8,000 or more document references, with only a few new or different documents since the last search. Sifting through all the returned document references to identify the new documents will surely prove to be very time consuming. There is a search result overload.

Furthermore, this process will be repeated over and over as the quest for new information continues.

Some search engines let a user specify that the search should return references to only recently modified documents. It is a step forward, but unfortunately this approach does not eliminate the search result overload. For example, a Google search for “journaling file system” with a restriction on documents modified in the last three months (the smallest time interval available) still returns about 4,500 document references. In many cases, the recent modification in these documents is unrelated to the query, and can be as trivial as a formatting change or link update.

If search engines could reliably return all the pages modified in the past two days, the search results would be more manageable. Unfortunately, this is not an easily achievable task. Because of the sheer number of web sites available on the Internet, the time required for a search engine to exhaustively crawl and index every site is normally measured in months, not days. In practice, a new document added to an already registered and crawled site may appear in the search engine results only weeks, or even months, after it has become available on the Internet.

Another approach for solving the search result overload problem, and providing incremental search results, has been the development of meta search engines. These meta search engines allow users to store queries, and then regularly query classic search engines and store the returned document references, and present to the user only the newly appearing document references. An example of such a meta search engine is presented in the paper “Effective Resource Discovery on the World Wide Web” by Markatos, et al., WebNet 98—World Conference of the WWW, Internet, and Intranet. Their software tool, called USEwebNET, allows a user to register queries, which are run against one or more search engines daily. The lists of document references returned by the search engines are merged, and presented to the user in a web page. The user is allowed to mark the documents he reads, which will not be presented to him again.

The same approach, consisting of providing a layer on top of existing search engines, is implemented and provided as a service to Internet users in the Tracerlock web site. This web site uses a different method for presenting new documents matching a stored query: the new document pointers, along with a small excerpt, are emailed at regular intervals to the user who has registered the query. Another similar web site, The Informant, is not active anymore.

While the meta search engine approach for providing incremental search results is useful, and simple to implement, it suffers from some important drawbacks:

Detection of new or changed documents is not timely, because of the time needed to crawl and index the Internet. Even when the crawler detects and downloads a new document, it will only be available to the search users when the global index is rebuilt. Rebuilding a global index for over two billion documents is an extremely time-consuming process, and the main search engines normally rebuild their global index once a month or even less frequently. As a result, it may take a month or more for meta search engines to detect new or changed documents.

Because of its reliance on existing search engines, the meta search engine works at the document level, without any insight regarding the actual content of the document. For example, once a document has matched a query, and even if it changes significantly and features new sections matching a user's query, it will not be presented to the user again.

Meta search engines may face legal challenges from the existing search engines they rely upon, as most search engines prohibit automated searches and reformatting of the search results returned. Existing search engines may also block meta search engines from accessing their sites using technological solutions.

The meta search engine approach for providing incremental search results doesn't scale easily to millions of users. One reason is that, for each query of each user, the meta search engine needs to regularly query existing search engines, download and parse the many pages of results, and store the results. For example, if the average query returns 5,000 matches, and 50 matches are displayed on each web page, 100 million web page downloads would be required to support one million users. This would likely seriously strain the underlying search engine.

Finally, because a meta search engine is relatively simple to implement, there is a weak barrier to entry. If such a service became popular and was able to charge significant usage fees, it would soon be emulated by a number of competitors.

Thus, there is a need for a new approach, allowing to provide incremental search results in a timely and efficient fashion to a large number of users.

### SUMMARY

The disclosed invention is a method, performed on a server computer system connected to a network, which allows to provide incremental search results to a large number of users in a timely and efficient fashion. Users submit queries, which are stored on the server computer system. Once a query has been submitted, it is automatically checked against any new or modified documents retrieved from the network by a difference crawler, and new matches are presented to the submitter of the query.

### DRAWINGS

FIG. 1 is a block diagram of a preferred embodiment of the present invention.

FIG. 2 is a flowchart of the steps performed by the difference crawler in a preferred embodiment of the present invention.

FIG. 3 is a partial flowchart, detailing the steps performed within block 224 of FIG. 2.

FIG. 4 is a data flow diagram of a preferred embodiment of the present invention, illustrating the case where both the display events and remove events originate from the users.

FIG. 5 is a flowchart of the steps performed by the first method of the difference crawler in another embodiment of the present invention.

FIG. 6 is a flowchart of the steps performed by the second method of the difference crawler in another embodiment of the present invention.

### DETAILED DESCRIPTION

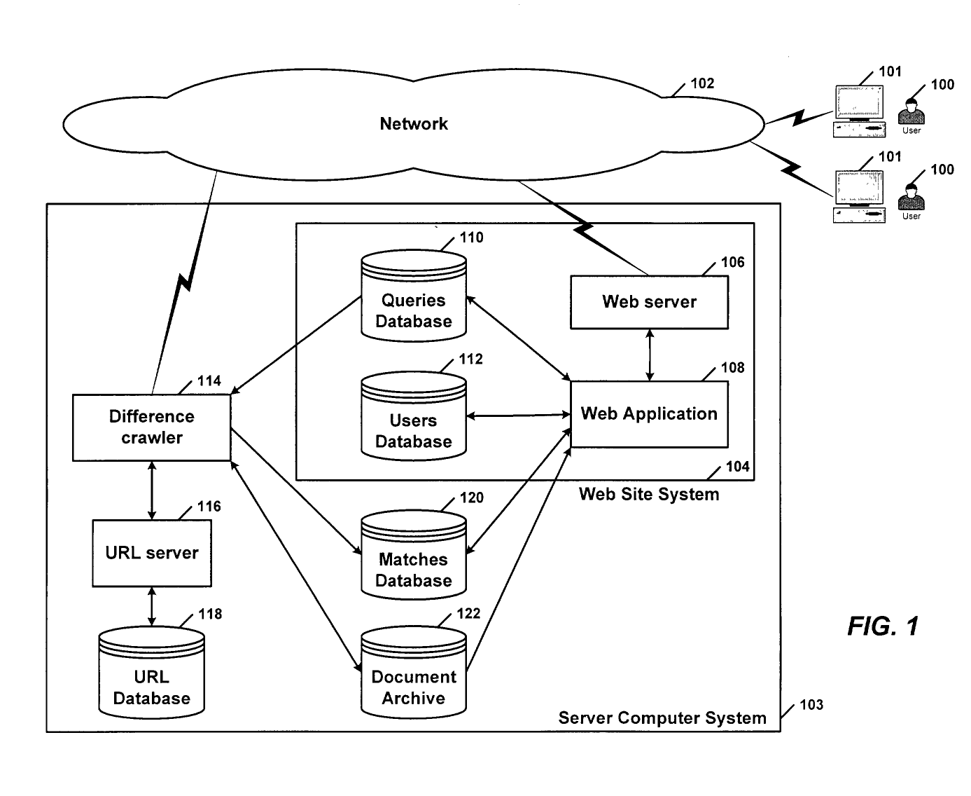

FIG. 1 is a block diagram of a preferred embodiment of the present invention. The method of the present invention is performed by server computer system 103, connected to network 102. Users 100, who typically are scattered across a large geographical area, use client computers 101 also connected to network 102 to interact with server computer system 103. The communication between client computers 101 and server computer system 103 is performed via communication protocols such as TCP/IP. Network 102 may be the Internet, or a private network. In practice, server computer system 103 may not be running on a single monolithic computer but rather on a network of interconnected server computers, possibly physically dispersed from each other, each dedicated to its own set of duties and/or to a particular geographical region.

Server computer system 103 includes a web site system 104, whose purpose is to manage the interaction with users 100. Web site system 104 includes a web server 106 and a web application 108, which together process HTTP (Hypertext Transfer Protocol) requests received over network 102 from users 100, and return HTML (Hypertext Markup Language) web pages which may be displayed in web browsers running on client computers 101. Web site system 104 may be used by users 100 for various purposes, such as: submitting queries to be processed by the incremental search engine, registering by providing a user identifier, password and possibly other personal information such as preferences or an email address; and viewing a list of pointers to new documents matching a previously submitted query. Web site system 104 includes queries database 110, which stores information about the queries submitted by users 100. The data stored for each query may include the text of the query and the email address of the submitter of the query. Web site system 104 may also includes users database 112, which stores information about registered users, such as the list of active queries submitted by a user, and the user's email address.

A query is a specification that a document must match to be included in the search result. A query can be very simple, such as a single word, in which case any document containing this word matches the query. More complex queries may include: multiple words; wildcards; regular expressions; Boolean operators such as “and”, “or” and “not”; quotation marks to search for exact phrases; grouping operators such as parentheses; special operators to match a given number of words out of a group.

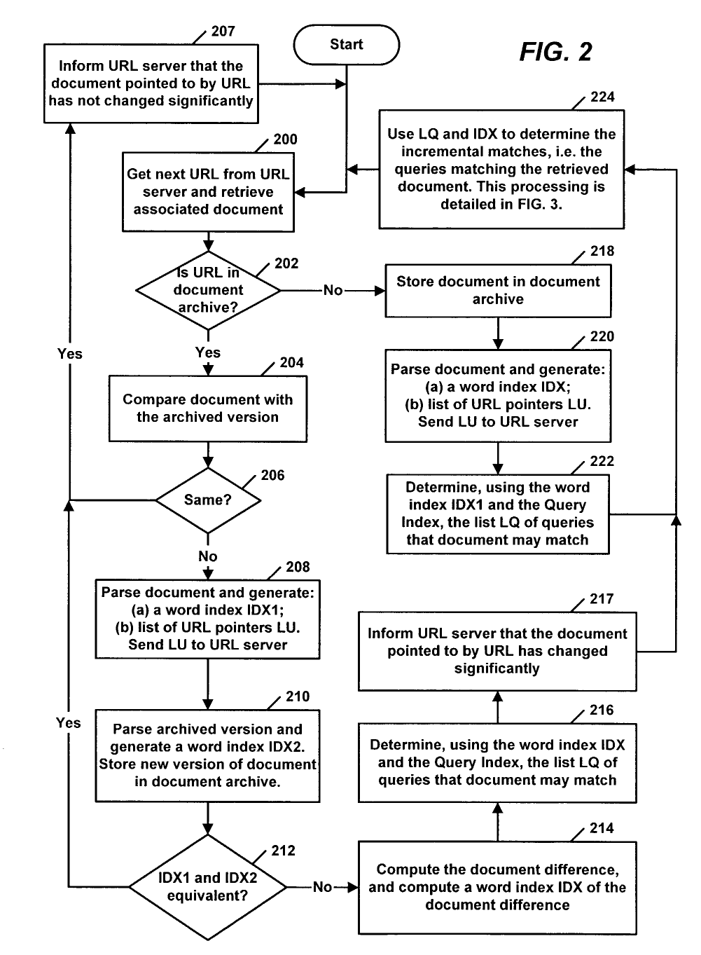

Server computer system 103 also includes difference crawler 114, which is a major component of the present invention. The method followed by difference crawler 114 in a preferred embodiment is detailed in FIG. 2, but a more high-level description is provided here. Difference crawler 114 can be understood as the integration of a classic web crawler, whose purpose is to retrieve documents available on a network, and a difference engine, whose purpose is to identify significantly novel documents and determine the queries matched by these significantly novel documents. In practice, Difference crawler 114 is likely to be implemented using multiple identical processes, distributed over several computers, in order to achieve a higher rate of document retrieval and processing.

Difference crawler 114 is a program that retrieves documents from a network. Often, these documents are stored on a large number of server computers, connected to the same network, and can be downloaded using the HTTP protocol by connecting to a web server. These documents are often web pages, formatted as HTML documents, but can also be provided in a variety of other formats including: Adobe Systems Incorporated PDF or PostScript formats; Microsoft Corporation Word (DOC), PowerPoint (PPT) or RTF formats, Macromedia Inc. Flash format; the World Wide Web Consortium XML format.

Difference crawler 114 may start by retrieving a first document. This first document, which will seed the crawling process, should be carefully chosen and can be a directory of other documents (for example, if the crawler is operating on the Internet, a good first document may be the top page of the DMOZ open directory). After the first document is retrieved, it is parsed and all the URLs (links to other documents) are extracted and sent to URL server 116. Then another URL is fetched from URL server 116 and the process is repeated. Other methods of submitting URLs to URL server 116, so that the associated documents will be crawled and available in incremental search results, may be used, such as allowing users 100 to submit URLs by using a web form.

URL server 116 has the important task of ordering the list of pages to be retrieved by difference crawler 114. Many factors may be taken into account for this ordering, such as: (a) the desire not to overwhelm a web site by firing many download requests in a short period of time; and (b) balancing between crawling new documents, in order to have a complete coverage of the available documents, and revisiting already crawled documents to detect changes. Methods for ordering the URLs to be retrieved by a classic web crawler have been studied and described in publications such as “Efficient Crawling Through URL Ordering” by Junghoo Cho, et al., and are applicable to URL server 116 and difference crawler 114 of the present invention. In general, methods for URL ordering are based on an importance metric, which is computed for each web page associated with an URL. The higher the importance metric of a web page, the more often it should be visited in order to have a fresh version. Often, the importance metric is based upon the global link structure of the documents available in the network, with the document most linked to being the most important. In the case of the present invention, the ordering may be based as well on a change metric, indicating the frequency and possibly amount of change in the associated document, in order to also take into account the frequency of significant changes in a web page. The rationale for using the change metric being that revisiting often web pages who change frequently will likely provide more incremental matches.

In order to perform its URL ordering method, URL server 116 needs to store information about the URLs already visited, why may for example include: the number of forward links from a given document; the outgoing links themselves; an importance metric; a change metric indicating the frequency and possibly amount of change in the associated document. This information is normally either provided by difference crawler 114 or computed by URL server 116, and is stored in URL database 118.

As documents are retrieved by difference crawler 114, they are stored, in a compressed format, in document archive 122. The document archive may be very large as it contains a complete image of every document retrieved. Document archive 122 is used for example by difference crawler 114 to compute differences between a previously retrieved document and the current version of a document, or by web application 108 to present to users 100 excerpts of the matching documents along with the matches. Normally, there is a one-to-one correspondence between URLs and documents, meaning that the document archive contains one and only one document for every URL. However, since the present invention focuses on differences and incremental changes, it may be desirable for the document archive to store multiple versions, or revisions, of each document, instead of only the latest version. This can be realized at a reasonable cost in terms of extra storage for example by storing the complete first version of the document, and a series of differences between successive versions. A typical implementation of such differential storage of multiple revisions of a single document is the RCS (Revision Control System) by Walter F. Tichy. Alternatively, the complete last version can be stored, along with a series of differences allowing to recreate previous versions. Document archive 122 may also contain other information about each document it stores, including for example the date and time each version of the document is stored in document archive 122.

While the crawling process implemented by difference crawler 114 is well understood in the prior art, an important part of the present invention is the difference engine, and the way it performs its processing in conjunction with the crawling process. Prior-art crawlers, used for example in classic search engines, discover significantly novel documents (defined as documents not previously retrieved or documents with significant modifications since the last visit of the crawler), but do not make timely use of this information. New versions of documents are simply stored in a document archive, which will be the base for the next generation of a global document index.

The addition of a difference engine allows difference crawler 114 to identify significantly novel documents and determine the queries matched by these significantly novel documents. In the preferred embodiment described here, the difference engine is integrated with the difference crawler 114, but it could be a separate process if it were to be integrated to a classic search engine architecture.

### Incremental Matches

When a query matches a significantly novel document, an incremental match is generated and stored in matches database 120. An incremental match contains all the information necessary to display the match to the user who submitted the query, with the exception of the document itself which is available in the document archive. An incremental match may include the following data: a query identifier, allowing to identify the query from queries database 110; a document identifier, possibly including a document version if multiple versions are stored in document archive 122; the word occurrences matching the query in the document, possibly including their location. It is useful to include the matching word occurrences in the incremental match as it allows to highlight them in the presented document excerpts.

### Query Index

One important task of difference crawler 114 is to determine the queries matched by significantly novel documents. In this embodiment, a significantly novel document may be checked for incremental matches as soon as it is retrieved from the network. It would be possible to try all active queries against an inverted index generated for each significantly novel document, but as there may be a very large number of queries this checking can become prohibitively time consuming. The query index speeds up this process significantly.

The query index is a data structure which allows to rapidly determine the list of queries which may match a significantly novel document. It is an inverted index where the words present in all the active queries are used as keys, and which allows to rapidly determine the list of queries containing any single word. When the query index is constructed, the Boolean operators within queries are substantially ignored, with some possible exceptions such as “not <word>” where <word>can be ignored and not included in the query index. Typically, the query index is regenerated from the queries database and made available to the difference engine at regular intervals, for example once per day.

Once the query index has been generated from all the active queries, it allows to rapidly determine the list of queries, if any, containing any single word. Then, the list of queries which may match a significantly novel document is the union of the lists of queries matching every new word in the document (or the result of the query, which is a logical “or” of all the new words contained in the document, ran against the query index)

This method is especially advantageous in the case of modified documents, as the list of words to be considered is the list of words added in the document since the last visit, and can be relatively short. This list is determined in two steps. First, the document difference of the document is determined, which consists of all the text fragments present in the newly retrieved version of the document, which were not already present in the archived version. The document difference is actually the novel portion of the document. This document difference is determined by first stripping both versions of the document of the formatting information, and then computing the difference of the new version of document minus the archived version of the document using a tool such as GNU diff, and taking into account only the added fragments (deleted fragments can be discarded). Second, the document difference is used to compute a word index, and from this word index the list of unique words present in the document difference can easily be determined.

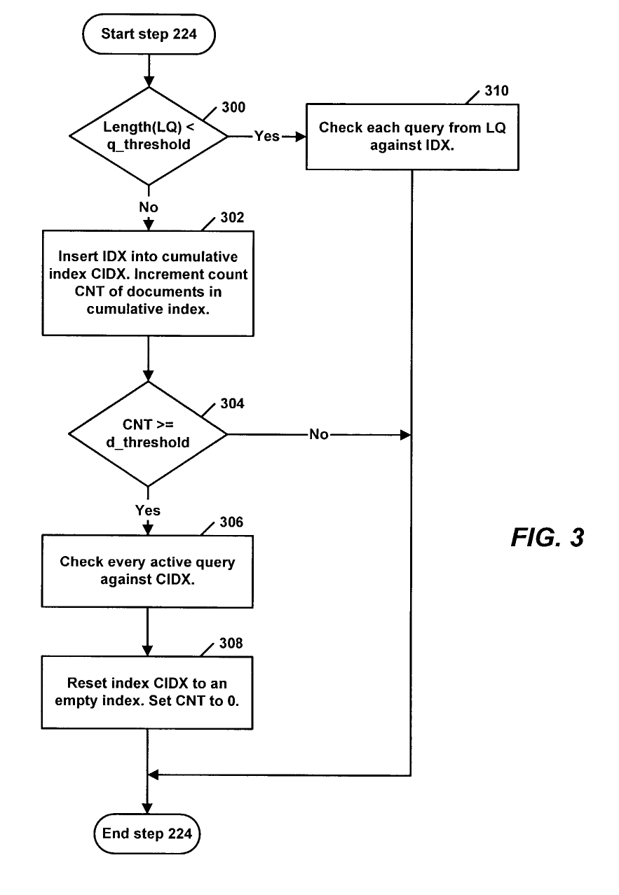

In the case of new documents or in documents having substantial additions, the number of queries which may match the document, as determined using the query index, may still be large. In this case, it may be advantageous to accumulate such document indices into an inverted word index, and periodically run all the active queries against this cumulative index. This processing is detailed in FIG. 3.

### FIG. 2: Flowchart of the Method Performed By Difference Crawler 114

FIG. 2 describes in detail the method used by difference crawler 114, and the integrated difference engine, in a preferred embodiment. It is important to note that, while the method is presented as a sequential process, it will typically be implemented as an I/O (Input/Output) event driven process, using asynchronous I/O, because it is desirable to keep many HTTP connections open simultaneously to maximize document retrieval efficiency.

In step 200, difference crawler 114 requests from URL server 116 the next URL to retrieve, and retrieves the associated document. If a version of this document, associated with the same URL, was already stored in document archive 122 (test 202), the newly retrieved document is compared with the archived version (step 204). If the newly retrieved document is the same as the archived version (test 206), there is no more processing to be done for this URL and the method loops back to step 200 to process another URL after informing the URL server that the document pointed to by URL has not changed significantly (step 207).

If no document associated with the URL is present in document archive 122 (test 202), then the newly retrieved document is stored in document archive 122 (step 218). In step 220, the document is parsed and a word index IDX is generated, as well as a list LU of URLs pointing to other documents. In the same step 220, the list LU of forward pointing URLs is sent to the URL server, in order to be considered for future crawling. Step 222 attempts to reduce the number of queries to run against the newly retrieved document, by creating a query which is a logical “or” of all the words contained in the newly retrieved document, and checking this query against the query index. The result is a list of queries LQ which may match the newly retrieved document. In step 224, which is detailed further in FIG. 3, LQ is used as well as IDX to determine the incremental matches for this newly retrieved document, i.e. the queries matching the retrieved document. After the incremental matches have been determined in step 224, difference crawler 114 loops back to step 200 to process another URL.

If there already was a document associated with the URL present in document archive 122 (test 202), and if the newly retrieved document is not the same as the archived version (test 206), then further checking is required as the document has been modified since last visited by difference crawler 114, and may match some queries.

One possibility is that only the formatting of the document changed, while the content stayed the same, in which case the change in the document is not significant with respect to the incremental search engine. This eventuality is considered in the following steps. In step 208, the newly retrieved document is parsed and a word index IDX1, containing all the word occurrences and their position in the document, is generated. In the same step, the list of forward document pointers, or URLs, is generated and sent to the URL server. This will allow these URLs to be considered for further crawling. In step 210, the archived version of the document is similarly parsed and a word index IDX2 is generated, and the newly retrieved version of the document is stored in document archive 122.

It should be noted that the index contains only the words occurrences from the document contents, but does not include the words used for formatting, such as HTML tags. As part of the parsing process, the formatting elements are stripped, and only the contents portion of the document is fed to the indexer. Therefore, the indices IDX1 and IDX2 describe precisely the contents of the newly retrieved and archived versions of the document, without the formatting. In test 212, indices IDX1 and IDX2 are compared. If they are equivalent, it means that only the formatting of the document changed, but not the content, so difference crawler 114 can loop back to step 200 to process another URL after informing the URL server that the document pointed to by URL has not changed significantly (step 207). In test 212, Instead of comparing the indices generated from both versions of the document, it is possible to directly compare the document versions stripped of the formatting, and this comparison would be equivalent to comparing the indices. If this approach is chosen, it is not necessary to generate the indices IDX1 and IDX2 in steps 208 and 210.

If the indices IDX1 and IDX2 are found not to be equivalent in step 212, it means that there has been a significant change in the document. In step 214, the document difference, i.e. the difference between the newly retrieved document and the archived version, is computed, and a word index IDX of the difference is generated. The difference is computed using a tool such as GNU diff, with the minimum context, and only the added words are kept. It may be advantageous to develop a specific program for computing this difference, which would take as input two lists of words, and would output strictly the added words with no contextual information, without taking any white space or formatting into consideration. In step 216, using the query index, the list LQ of queries, which may match the newly retrieved document because of the change in the document since it was visited last, is determined. LQ is the result of running the query which is a logical “or” of all the words contained in the difference against the query index.

In step 217, the URL server is notified that the document pointed to by URL has changed significantly. Step 217 is followed by step 224, detailed further in FIG. 3, where LQ is used as well as IDX to determine the incremental matches for this newly retrieved document. After the incremental matches have been determined in step 224, difference crawler 114 loops back to step 200 to process another URL.

### FIG. 3: Detail of Steps Performed in Block 224 of FIG. 2.

The flowchart of FIG. 3 describes the process for determining the incremental matches for the document. A list LQ of queries which may match the document, as well as a word index IDX of the document difference of the document, have been computed. The process described here attempts to reduce the time required for determining the incremental matches.

In test 300, the number of queries in the list LQ is compared to a predetermined threshold value: q_threshold. If the number of queries is small (lower than q_threshold), each one of them can efficiently be run against the word index IDX to determine the queries matching the document, which is what is done in step 310. In this step, each query from LQ is checked against IDX, and for every match an incremental match is generated and stored in matches database 120.

If there is a large number of queries in LQ (greater or equal than q_threshold), running every one of these queries against IDX would be too time consuming. So instead of running a large number of queries against every significantly novel document, it is preferable to create a cumulative index for many documents, and periodically run all the active queries against this cumulative index. This is what is described in FIG. 3, steps 302 to 308.

In step 302, we add the index IDX of the document to the cumulative index CIDX, and we increment the count CNT of documents on CIDX. In test 304, the count CNT of documents on CIDX is compared to a predetermined threshold value: d_threshold. If the count of documents is greater or equal than the threshold, then every active query is checked against CIDX, and for every match an incremental match is generated and stored in matches database 120. In step 308, the cumulative index CIDX is reset to an empty index, as all the documents have been processed, count CNT is reset to 0, and step 224 ends. If in test 304, the count of documents in CIDX was lower than the threshold d_threshold, step 224 ends immediately.

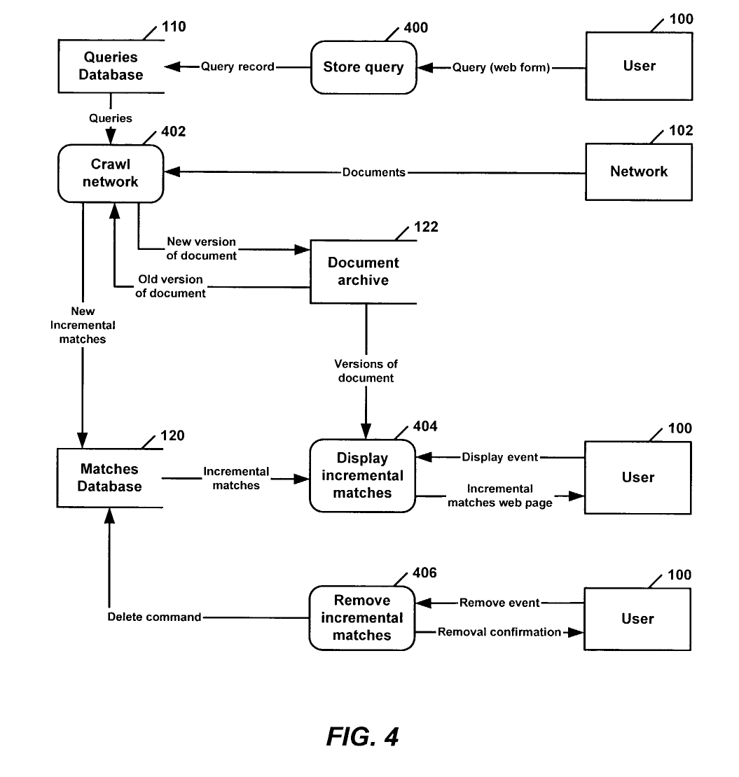

### FIG. 4: Data Flow Diagram of a Preferred Embodiment of the Present Invention

In FIG. 2 and FIG. 3, the method for determining the incremental matches, using a difference crawler, has been described. FIG. 4 is a data flow diagram showing a more global view of a preferred embodiment of the present invention, including: presenting the incremental matches to a user; and deleting the incremental matches no longer useful to the user from matches database 120.

The presentation of the incremental matches to a user is triggered by a display event. The display event may originate from a user action, such as the user clicking on a web page link, or from a software event such as a timer, which would for example cause the incremental matches information to be emailed to the user. Multiple types of sources for a display event can be supported by an embodiment of the present invention. For example, a first display event can originate from a timer causing a list of incremental matches, including URL links to web site system 104, to be emailed to the user. Upon receiving this email, the user may click on one of the URL links to view more detailed information about one of the incremental matches, and this click would send a HTTP request to web site system 104. Upon arrival at web site system 104, this HTTP request would be interpreted as a display event. A display event normally includes a user identifier and/or a query identifier or an incremental match identifier.

Similarly, the remove event can originate either from a user action, or from a software event such as a timer, or both. For example, in an embodiment of the present invention, the full information about the newly detected incremental matches can be emailed to the user, and the incremental matches removed from matches database 120 immediately thereafter. In this case, the display event and the remove event could both originate from the same source, for example a daily timer event. One advantage of this solution would be to minimize the amount of storage needed for matches database 120, as the method would not rely on the users to delete incremental matches.

It may also be possible, in such an embodiment, to charge users for the incremental search service according to the frequency of the email notifications of new incremental matches. For example, users paying a minimum fee would be notified once a day of new incremental matches, while users paying a premium fee may be notified hourly (provided a new incremental match has been found), or even as soon as the incremental match is detected by the difference crawler.

In another embodiment, the incremental search engine is a repository of the user information, storing incremental matches until explicitly deleted by the user. In this case, the display events and remove events both originate from the users. This is the embodiment described in FIG. 4.

In FIG. 4, a user 100 submits a query with the incremental search engine by filling in a web form in their web browser. A user may, or may not, have to register and log in to web site system 104 in order to submit a query. Requiring registration facilitates the management of multiple queries, and also allows the web site operator to bill fees for the search services performed, but is often a deterrent for casual users. Process 400 of the web site system receives the HTTP request and stores a representation of the query in queries database 110. Process 402, implemented by difference crawler 114, crawls network 102 and retrieves new versions of documents from network 102, retrieves old versions of documents and stores new versions of documents in document archive 122, generates incremental matches using queries database 110, and finally stores these incremental matches in matches database 120. Upon receiving a display event originating from a user 100, a display process 404, using data from matches database 120, queries database 110 and document archive 122, sends to user 100 a web page displaying information about the incremental matches. Upon receiving a remove event originating from a user 100, a remove process 406 deletes the matches specified in the remove event from matches database 120.

FIG. 4 shows an embodiment of the present invention where both the display events and remove events originate from the users. However, in order to limit storage requirements for the matches database, it may be necessary to automatically remove old incremental matches, or the incremental matches attached to inactive user accounts. This can be implemented by a garbage collection software program, which would be run at regular intervals, and would generate remove events as deemed necessary.

### Presenting Incremental Matches

For each query submitted by a user, the difference engine continuously crawls the network in search of substantially novel documents matching this query. Once such documents have been found and incremental matches have been generated, those incremental matches need to be presented to the submitter of the query.

A natural way to present these incremental matches is a list of matching documents, attached to a query, similar to the way classic search engines present the results of a search. Each matching document is described by various attributes, which may include: a link to the document itself with the document title as the descriptive text of the link, allowing to directly view the document in a browser by clicking on the link; the URL of the document; one or more excerpts from the documents, containing the highlighted query keywords; a link to the cached version of the document in the document archive, in which the incremental match was detected; a link to the latest cached version of the document in the document archive; a link to a program in the incremental search engine web site returning a graphical display of the changes in the document between the version in which the incremental match was detected and the previous version. For graphically displaying differences between different versions of documents, a variety of software packages can be used, including Docucomp from Advanced Software, Inc or HtmlDiff by Fred Douglis.

When displaying the incremental matches, a link should be provided, next to each query, allowing to deactivate the query. This link, when clicked, would cause the associated query to be removed, or marked as expired, from queries database 110. Another case when a query may be deleted, or marked as expired, is when the emails sent to a user bounce for a prolonged time period. It may be desirable to have the queries automatically expire after a given time period, such as one month. If this is implemented, another link may be provided to reactivate the query.

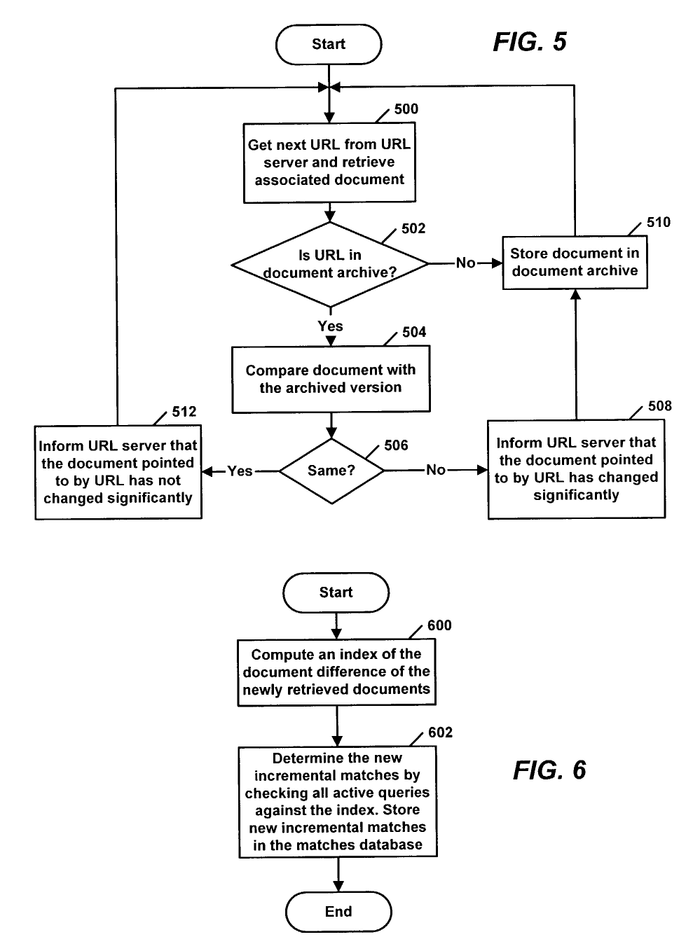

### Dissociating Crawling and Indexing—FIG. 5 and FIG. 6

At a slight cost in timeliness of the detection of incremental matches, it may be more efficient to dissociate the crawling process from the indexing process. Another preferred embodiment of the present invention, achieving this goal, is presented here.

In this embodiment, document archive 122 is able to store multiple versions, or revisions, of each document, instead of only the latest version, and difference crawler 114 is split in two separate methods. The first method, responsible for retrieving significant novel documents from network 102 and storing these in document archive 122, is described FIG. 5. The second method, responsible for determining the incremental matches, is described FIG. 6.

FIG. 5 is a flowchart of the first method of difference crawler 114. This is a method that, once started, runs substantially continuously. In step 500, difference crawler 114 requests, from URL server 116, the next URL to retrieve, and retrieves the associated document. If a version of this document, associated with the same URL, was already stored in document archive 122 (test 502), the text of the newly retrieved document, stripped of all formatting information, is compared with the archived version, also stripped of all formatting information (step 504). If the text of the newly retrieved document is the same as the archived version (test 506), there is no more processing to be done for this URL and the method loops back to step 500 to process another URL after informing the URL server that the document pointed to by URL has not changed significantly (step 512).

If no document associated with the URL is present in document archive 122 (test 502), then the newly retrieved document is stored in document archive 122 (step 510), including a timestamp of the current time, and the method loops back to step 500 to process another URL.

If the text of the newly retrieved document is different from the text of the archived version (test 506), then in step 508 the URL server is notified that the document pointed to by URL has changed significantly, and in step 510 the new version of the document is stored in document archive 122, including a timestamp of the current time. After step 510, the method loops back to step 500 to process another URL.

The first method of difference crawler 114, described in FIG. 5, finds significantly novel documents in the network and stores them the document archive 122. The second method of difference crawler 114 is repeated at predetermined intervals (for example once per day, or once for every d_threshold substantially novel documents retrieved), and determines new incremental matches using document archive 122. This second method is described in FIG. 6.

In step 600 of FIG. 6, an inverted word index (the index) is constructed from the document difference of the recently modified documents from document archive 122. The recently modified documents are the documents which have had a new version stored since the last time the method of FIG. 6 was performed. The document difference of a document consists of all the text fragments, present in the last version of the document, which were not present in the previous version, or is the complete document if a single version of it exists in document archive 122. The document difference of a document is determined using a software program such as GNU diff, run against the last two versions of the recently modified documents from document archive 122. Because the index contains only the documents modified since the last time the method of FIG. 6 was performed, it can be generated in a short time, and will likely be orders of magnitude smaller than a global index of all the documents in document archive 122.

In step 602, all the active queries from queries database 110 are checked against the inverted word index constructed in the previous step, and incremental matches are generated and stored in matches database 120 for every match. The remainder of the method of the present invention is the same as described for the first preferred embodiment.

### Integration to a Classic Search Engine

It is possible, and even desirable, to integrate the incremental search engine with a classic search engine. This combination would allow a user to submit queries for performing immediate searches against a pre-computed global index, with the search results including for example an additional “Keep me updated” button. This button, when pressed, would start a process that would retrieve the user's email address (possibly from a cookie or by using a web form), and register the incremental search query in the queries database. This would allow the user to be notified when new documents matching his original query become available on the network.

Integrating the incremental search engine of the present invention with a classic search engine is straightforward. The methods described in FIG. 2, FIG. 3, FIG. 4, FIG. 5 and FIG. 6 remain essentially the same, and are integrated in the web crawler of the classic search engine.

### Conclusion, Ramifications and Scope of Invention

Thus the reader will see that the method of the present invention allows to provide incremental search results to a large number of users in a timely and efficient fashion. Some important features of the present invention include:

Since incremental matches are detected by the difference crawler, and do not require a global index of all the documents available on the network to be rebuilt, there is a minimal delay between the crawling of a substantially novel document, and the detection of the incremental matches for this document. This can be a substantial advantage in case of rapidly changing documents, or when a timely notification is essential, such as “for sale” listings.

Thanks to the computation of the document difference, new incremental matches can be detected and presented to a user, even if the document was already matching. This is another significant advantage. For example, a web page on the internet may be listing multiple cars for sale, including an old listing for a “Ford Expedition” at an inflated price. The incremental search engine of the present invention would be able to notify a user who had submitted a query for a “Ford Expedition” when, and only when, a new matching listing appears on the web page.

The method is self-sufficient, and does not rely on existing search engines.

The method of the present invention can be efficiently distributed between a large number of processes, running on multiple computers, and does not require significant per-user storage space. As a result, the incremental search engine of the present invention can easily scale to a large number of users.

While the above description contains many specificities, these should not be construed as limitations on the scope of the present invention, but rather as an exemplification of one preferred embodiment thereof. Many other variations are possible. For example:

Queries may be stored (and retrieved from the query index), in a compiled form, in order to speed up their processing in the difference crawler.

Targeted versions of the incremental search engine may be provided, for example one version dedicated to searching “for sale” listings.

Users may be allowed to submit web sites for inclusion in the crawling process, in which case those sites would be added in the URL database.

Users may be allowed to request that the frequency at which a given web site is visited by the difference crawler be increased.

Queries database 110, users database 112 and matches database 123 may be combined in a single database, which may prove advantageous as relations exist between these databases (for example incremental matches, stored in the matches database, are attached to queries).

The web site system could provide facilities allowing users to store and organize their search results. For example users could be allowed to create a hierarchy of folders and store document pointers returned by regular or incremental searches in the appropriate folders. Incremental search results could be directed to flow directly into the appropriate folder. Further on, this folder hierarchy containing document pointers could be used as a remote database of bookmarks, which may be invoked from a toolbar installed in the user's browser.

Accordingly, the scope of the present invention should be determined not by the embodiment(s) illustrated, but by the appended claims and their legal equivalents.

In the claims which follow, reference characters used to denote process steps are provided for convenience of description only, and not to imply a particular order for performing the steps or that the steps are not overlapping.

I claim:

1. A method for providing incremental search results to at least one user, performed on a server computer system connected to a network, the method comprising the steps of:
(a) providing a web site system that includes a queries database, and that provides services for allowing the user to submit at least one query, wherein information about the queries is stored in the queries database;
(b) discovering a plurality of substantially novel documents available on the network, using a difference crawler;
(c) for each substantially novel document discovered, determining a list of incremental matches, the incremental matches representing matches between queries stored in the queries database and the substantially novel document;
(d) storing the incremental matches in a matches database;
(e) presenting to the user, upon a display event, the incremental matches from the matches database corresponding to the queries submitted by the user;
(f) deleting from the matches database, upon a remove event, at least some of the incremental matches corresponding to the queries submitted by the user.

2. The method of claim 1, wherein step (c) includes using a query index for efficiently determining a list of queries which may match the substantially novel document, whereby the number of queries to check against the substantially novel document may be greatly reduced.

3. The method of claim 2, wherein step (c) includes determining a document difference of the substantially novel document, by computing a difference between the substantially novel document and a previous version of the substantially novel document, and wherein only said document difference is taken into account when determining the incremental matches.

4. The method of claim 1, wherein step (c) includes determining a document difference of the substantially novel document, by computing a difference between the substantially novel document and a previous version of the substantially novel document, and wherein only said document difference is taken into account when determining the incremental matches.

5. The method of claim 1, wherein step (c) includes accumulating indices of a predetermined number of substantially novel document into a cumulative index, and then checking all active queries against the cumulative index in order to determine the incremental matches.

6. The method of claim 4, wherein step (c) includes accumulating indices of the document difference of a predetermined number of substantially novel document into a cumulative index, and then checking all active queries against the cumulative index in order to determine the incremental matches.

7. The method of claim 1, wherein the web site system includes a users database, and provides services for allowing users to register in order to easily manage the queries they have submitted.

8. A method for providing incremental search results to at least one user, performed on a server computer system connected to a network, the method comprising the steps of:
(a) providing a web site system that includes a queries database, and that provides services for allowing the user to submit at least one query, wherein information about the queries is stored in the queries database;
(b) providing a document archive capable of storing multiple versions of a plurality of documents;
(c) executing, substantially all the time, a web crawling process charged with discovering a plurality of substantially novel documents available on the network; and storing the substantially novel documents in the document archive;
(d) at predetermined intervals, and using the document archive, performing the second method comprising the steps:
(i) determining a document difference for each substantially novel document discovered since the last time the second method was performed, using the document archive;
(ii) generating an index of the document differences;
(iii) determining a plurality of incremental matches by checking the queries against said index.
(iv) storing the incremental matches in a matches database;
(e) presenting to the user, upon a display event, the incremental matches from the matches database corresponding to the queries submitted by the user;
(f) deleting from the matches database, upon a remove event, at least some of the incremental matches corresponding to the queries submitted by the user.

9. A method for providing incremental search results to at least one user, performed on a server computer system connected to a network, the method comprising the steps of:
(a) providing a web site system that includes a queries database, and that provides services for allowing the user to submit at least one query, wherein information about the queries is stored in the queries database;
(b) discovering a plurality of substantially novel documents available on the network;
(c) for each substantially novel document discovered, determining a document difference by comparing the document with a previously retrieved version of the same document;
(d) determining a plurality of incremental matches by checking the queries from the queries database against an index generated using the document differences;
(e) presenting to the user the incremental matches corresponding to the queries he submitted.
